(19) United States
(12) Patent Application Publication
(10) Pub. No.: US 2007/0166050 A1
(43) Pub. Date: Jul. 19, 2007

(54) Optical communication module

(75) Inventors: Tomoharu Horio, Kyoto (JP); Junji Fujino, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi, Kyoto (JP)

(21) Appl. No.: 10/586,956

(22) PCT Filed: Feb. 4, 2005
(86) PCT No.: PCT/JP05/01676

§ 371 Date: Jul. 25, 2006

(30) Foreign Application Priority Data
Feb. 5, 2004 (JP) 2004-029383

(51) Int. Cl. H04B 10/00

(52) U.S. Cl. 398/164

(57) ABSTRACT

An infrared communication module (A1) includes a sealing resin member (5) formed with an inclined surface (5b) positioned adjacent to a lens (5a) and inclined in both of the x direction in which an LED (2) and a photodiode (3) are arranged side by side and the y direction extending from the LED (2) to the lens (5a). The light refracted upon passing through the inclined surface (5b) is received by the photodiode (3). With this arrangement, the size of the infrared communication module (A1) can be reduced.

### TECHNICAL FIELD

The present invention relates to an optical communication module such as an infrared communication module.

### BACKGROUND ART

Recently, a cell phone has been proposed which has data communication function for performing transmitting and receiving of data such as an image with a personal computer or other devices. An infrared communication module may be utilized for such data communication (Patent Document 1, for example).

FIG. 8 shows an example of conventional infrared communication module. The illustrated infrared communication module X includes a substrate 91 on which an LED 92 for emitting infrared light, a photodiode 93 for receiving and detecting infrared light and an IC chip 94 for controlling these elements are mounted. The LED 92, the photodiode 93 and the IC chip 94 are sealed in a sealing-resin member 95. The sealing resin member 95 is formed with two convex lenses 95a and 95b. The lens 95a functions to enhance the directivity of light emitted from the LED 92 and guide the light efficiently toward the data transmission destination. The lens 95b functions to converge the light traveling thereto onto the light-receiving surface of the photodiode 93.

When the infrared communication module X is to be incorporated in the housing of a cell phone for use, the module is so mounted that the lenses 95a and 95b are exposed through an opening formed in the housing. To reduce the thickness of a cell phone and diversify the design, the opening should be as small as possible. For this purpose, the lenses 95a and 95b should not be bulky. Therefore, in the infrared communication module X, the lenses 95a and 95b are arranged to partially come into contact with each other.

However, the above-described infrared communication module X has the following problems.

Firstly, to reduce the entire size, it may be desired that the LED 92 and the photodiode 93 are arranged close to each other. Conversely, to secure the space for the wiring on the substrate 91, it may be desired that the distance between the LED 92 and the photodiode 93 is relatively large. However, to properly converge light by the lenses 95a and 95b, the LED 92 and the photodiode 93 need to be positioned on the central axis C₅ₐ of the lens 95a and on the center axis C_{5b} of the lens 95b, respectively. Therefore, in the conventional structure, the degree of freedom in the arrangement of the LED 92 and the photodiode 93 is small, so that sometimes the above-described desire cannot be fulfilled.

Secondly, the lenses 95a and 95b are partially held in contact with each other for size reduction. However, the smaller the center-to-center distance between the lenses 95a and 95b, the smaller the area for transmitting infrared light becomes. When the area is small, the function of the lenses 95a and 95b as a lens is degraded, which may cause deterioration of communication performance such as infrared transmission performance or receiving sensitivity of infrared light.

Patent Document 1: JP-A-2001-168376 (FIG. 1)

### DISCLOSURE OF THE INVENTION

### Problems to be Solved by the Invention

The present invention is conceived under the above-described circumstances. It is, therefore, an object of the present invention to increase the degree of freedom in design of an optical communication module without causing disadvantages such as deterioration of communication performance.

### Means for Solving the Problems

To solve the above-described problems, the present invention takes the following technical measures.

According to the present invention, there is provided an optical communication module comprising a substrate, a light emitting element and a light receiving element mounted on the substrate, and a sealing resin member covering the light emitting element and the light receiving element and capable of transmitting light emitted from the light emitting element. The sealing resin member is formed with a lens positioned to face the light emitting element. The sealing resin member is further formed with an inclined surface positioned adjacent to the lens. The inclined surface is inclined in both of a first direction in which the light emitting element and the light receiving element are arranged side by side and a second direction extending from the light emitting element to the lens. The light refracted in passing through the inclined surface is received by the light receiving element.

Preferably, the inclined surface is so inclined in the first direction that the inclined surface becomes closer to the substrate as proceeding away from the lens.

Preferably, the inclined surface is entirely or partially curved convexly as viewed in the first direction.

Preferably, the inclined surface is so inclined in the first direction that the inclined surface becomes farther from the substrate as proceeding away from the lens.

Preferably, the lens projects in a direction to become farther from the substrate than the inclined surface is.

Preferably, the light emitting element is capable of emitting infrared light, whereas the light receiving element is capable of receiving and detecting infrared light.

Other features and advantages of the present invention will become more apparent from the following description of embodiments of the invention.

### BRIEF DESCRIPTION OF THE DRAWINGS

FIG. 1 is an overall perspective view showing an example of infrared communication module according to the present invention.

FIG. 2 is a sectional view taken along lines II-II in FIG. 1.

FIG. 3 is an overall perspective view showing another example of infrared communication module according to the present invention.

FIG. 4 is a sectional view taken along lines IV-IV in FIG. 3.

FIG. 5 is an overall perspective view showing another example of infrared communication module according to the present invention.

FIG. 6 is an overall perspective view showing another example of infrared communication module according to the present invention.

FIG. 7 is a sectional view taken along lines VII-VII in FIG. 6.

FIG. 8 is an overall perspective view showing another example of infrared communication module according to the present invention.

FIG. 9 is a sectional view showing an example of conventional structure.

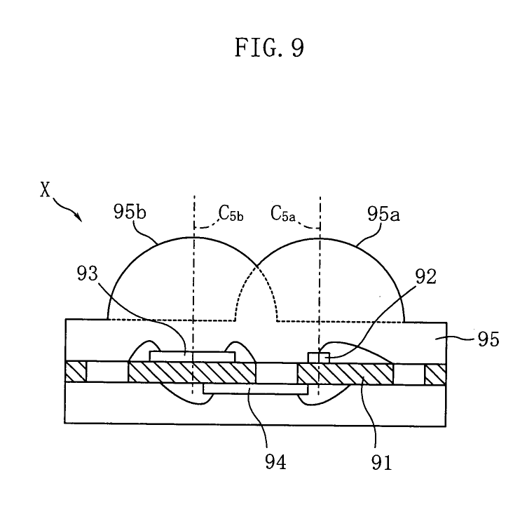

### BEST MODE FOR CARRYING OUT THE INVENTION

Preferred embodiments of the present invention will be described below with reference to the accompanying drawings.

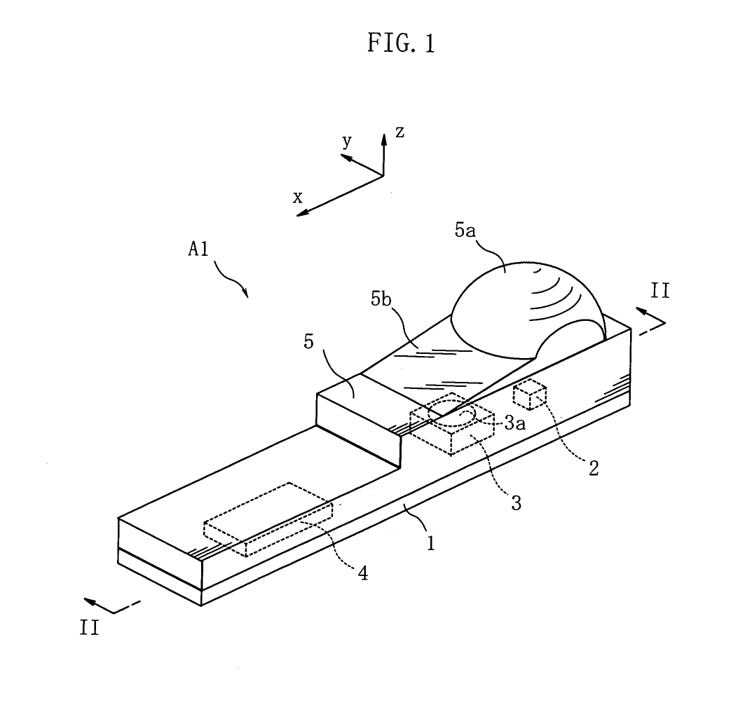

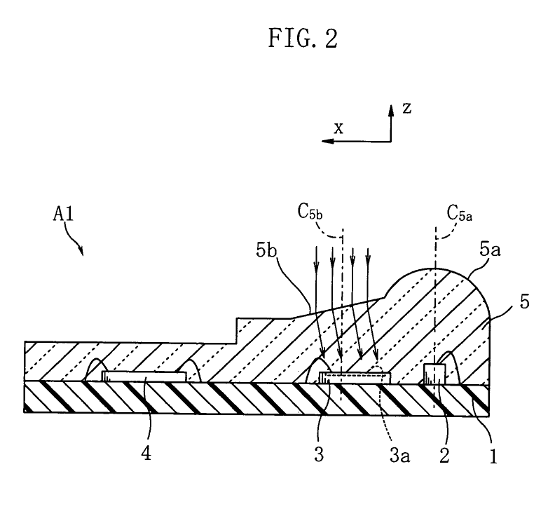

FIGS. 1 and 2 show an example of infrared communication module according to the present invention. The infrared communication module A1 in this embodiment may be incorporated in a cell phone (not shown) for data communication between cell phones or between a cell phone and other kinds of devices such as personal computers. The infrared communication module Al includes a substrate 1, an LED 2, a photodiode 3, an IC chip 4 and a sealing resin member 5. In the figures, the directions indicated by x, y and z are perpendicular to each other. The x and z directions correspond respectively to the first and second directions of the present invention.

The substrate 1 is in the form of an elongated rectangle in plan view and made of an insulating material such as glass epoxy resin.

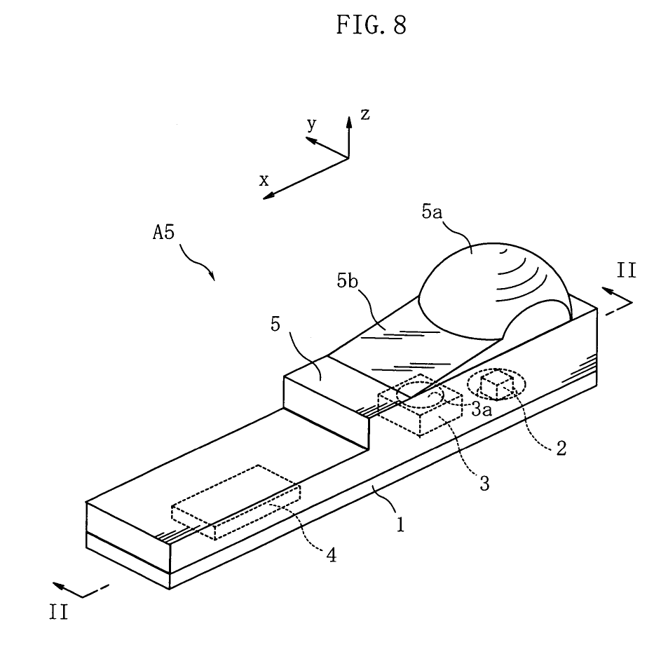

The LED 2 is an example of light emitting element according to the present invention and capable of emitting infrared light. The LED 2 is mounted on the substrate 1 at a position adjacent to an end of the substrate. Unlike this embodiment, a reflector surrounding the LED 2 may be provided as shown in FIG. 8, where the substrate 1 is formed with a recess, on whose bottom surface the LED 2 is mounted. Thus, inner side surfaces of the recess serve as a reflector. With this structure, the light emitted from the LED 2 can be efficiently utilized.

The photodiode 3 is an example of light receiving element according to the present invention and includes a light receiving portion 3a. When the light receiving portion 3a receives infrared light, the photodiode 3 flows current corresponding to the infrared light by photovoltaic effect. The photodiode 3 is arranged close to the center of the substrate 1 in the x direction and mounted side by side with the LED 2.

The IC chip 4 functions to cause the LED 2 to emit light correspondingly to a signal to be transmitted or convert the current from the photodiode 3 to an output signal and output the signal to a controller mounted in the cell phone. The IC chip 4 is mounted on the substrate 1 at a position adjacent to the end opposite from the LED 2.

The sealing resin member 5 is formed by transfer molding of an epoxy resin containing a pigment, for example, and seals the LED 2, the photodiode 3 and the IC chip 4. The sealing resin member 5 transmits infrared light sufficiently but does not transmit visible light. The sealing resin member 5 includes an upper portion formed with a lens 5a and an inclined surface 5b. The lens 5a is provided to face the LED 2 in the z direction and bulges upward in the figure. The lens 5a functions to enhance the directivity of the infrared light emitted from the LED 2. The inclined surface 5b is positioned above the photodiode 3 in the figure and comprises a flat surface connected to the lens 5a. The inclined surface 5b is so inclined that the height of the inclined surface 5b from the substrate 1 gradually reduces as proceeding away from the LED 2 in the x direction.

As shown in FIG. 2, the center of the LED 2 generally corresponds to the central axis C₅a of the lens 5a. The center of the photodiode 3 is offset from the central axis C5b of the inclined surface 5b toward the LED 2.

The operation and advantages of the infrared communication module A1 will be described below.

As shown in FIG. 2, in the infrared communication module A1, the light traveling from an upper portion in the figure toward the inclined surface 5b passes through the inclined surface 5b while being refracted toward the LED 2. The photodiode 3 is mounted adjacent to the LED 2 to properly receive the refracted light. Therefore, the space between the photodiode 3 and the LED 2 can be saved. As a result, the dimension of the substrate 1 in the x direction can be reduced, whereby the size of the infrared communication module 1 can be reduced. Further, the space on the substrate 1 between the photodiode 3 and the IC chip 4 can be increased, so that another electronic part can be additionally mounted, for example.

As shown in FIG. 2, the distance between the central axis C₅ₐ of the lens 5a and the central axis C_{5b} of the inclined surface 5b can be increased. When this center-to-center distance is small, the area of the lens 5a or the inclined surface 5b becomes small. In such a case, the amount of infrared light which the photodiode 3 receives through the inclined surface 5b is reduced, so that the light receiving sensitivity of the photodiode 3 is degraded. Alternatively, the light conversion effect by the lens 5a becomes insufficient, so that the directivity of infrared light emitted from the LED 2 becomes insufficient. In the infrared communication module A1, however, such problems can be solved by increasing the area of the inclined surface 5b and the lens 5a.

As shown in FIG. 2, the top portion of the inclined surface 5b is lower than the top portion of the lens 5a, and the inclined surface is not so bulky in the height direction of the substrate 1 as compared with the lens 5a. Therefore, in the infrared communication module A1, the volume of the sealing resin member 5 can be reduced to reduce the entire size and thickness, as compared with the conventional structure in which two lenses which are similar to the lens 5a are arranged side by side, for example.

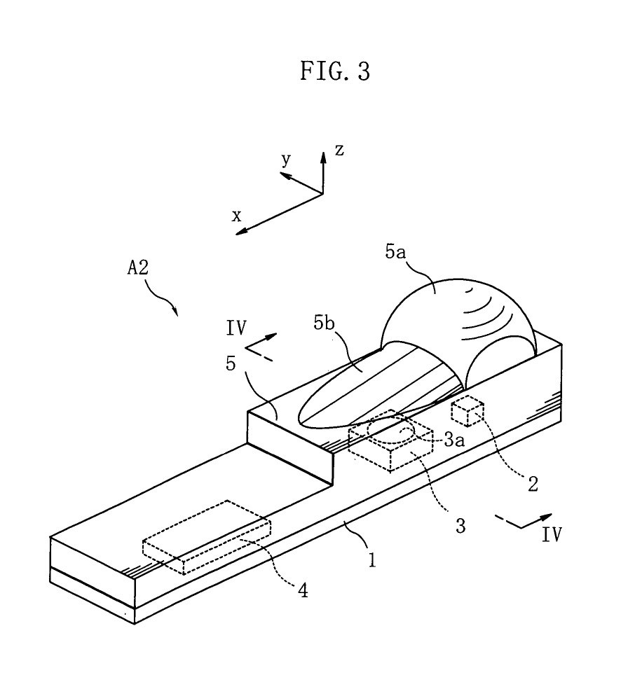

FIGS. 3-7 show other examples of infrared communication module according to the present invention. In FIG. 3 and the subsequent figures, the elements which are identical or similar to those of the foregoing embodiment are designated by the same reference signs as those used for the foregoing embodiment.

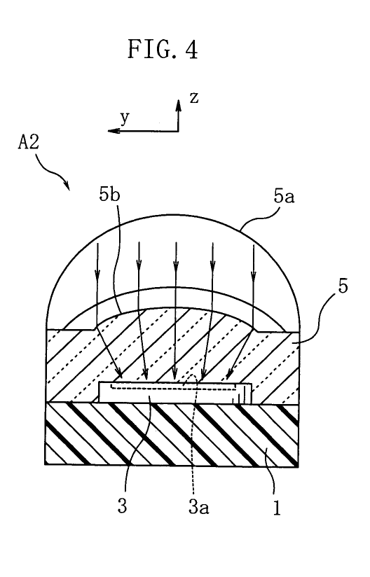

In the infrared communication module A2 shown in FIGS. 3 and 4, the inclined surface 5b is convexly curved to bulge upward as viewed in the x direction.

According to this embodiment, the inclined surface 5b functions as a lens for converging infrared light in the y direction, as shown in FIG. 4. Therefore, the amount of infrared light received by the photodiode 3 is increased, so that the light receiving sensitivity of the photodiode 3 can be advantageously enhanced. To make the inclined surface 5b function as a lens, only part of the inclined surface 5b may be convexly curved instead of convexly curving the entirety of the inclined surface 5b.

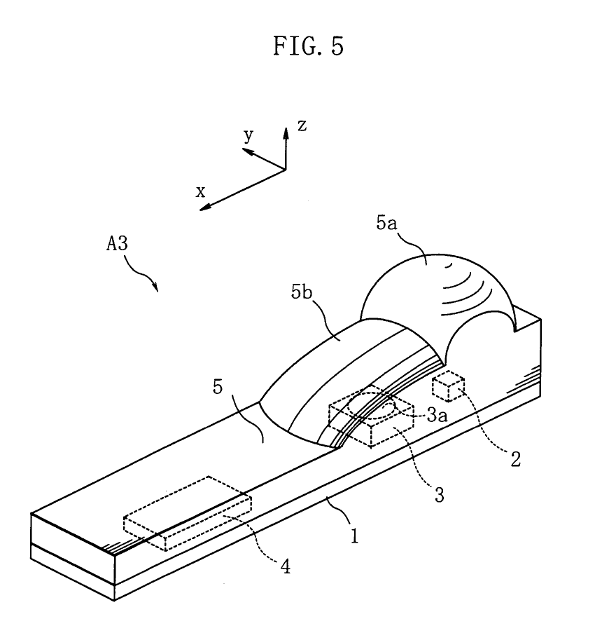

In the infrared communication module A3 shown in FIG. 5, the inclined surface 5b does not extend straight but forms a curve as viewed in the y direction. Further, similarly to the infrared communication module A2, the inclined surface 5b is convexly curved to bulge upward as viewed in the x direction.

According to this embodiment, similarly to the embodiments shown in FIGS. 3 and 4, the infrared light received by the inclined surface 5b can be converged in the y direction. Further, the infrared light can be converged to some degree also in the x direction. Therefore, the amount of infrared light which the photodiode 3 receives can be further increased.

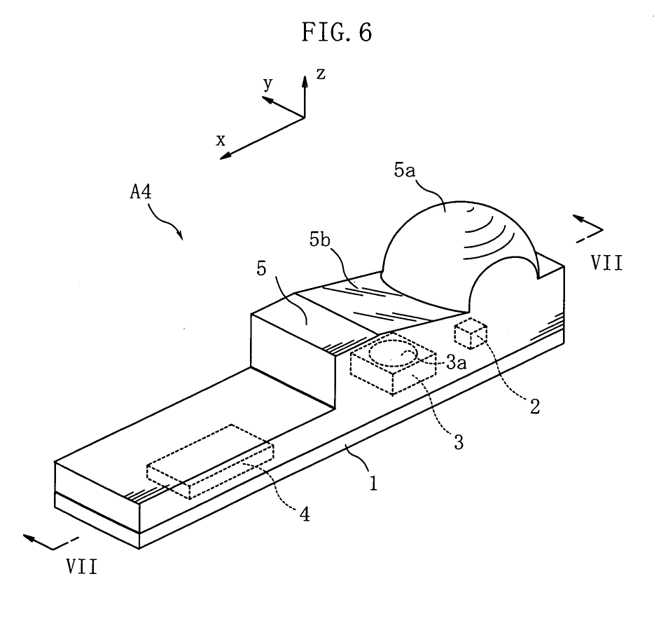

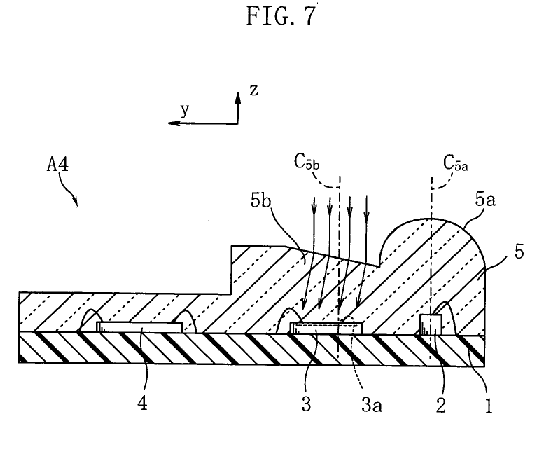

In the infrared communication module A4 shown in FIGS. 6 and 7, the height of the inclined surface 5b from the substrate 1 increases as proceeding away from the lens 5a in the x direction. That is, in this embodiment, the inclination direction of the inclined surface 5b is opposite from that of the infrared communication module A1 shown in FIGS. 1 and 2.

As better shown in FIG. 7, the light traveling from an upper portion in the figure toward the inclined surface 5b passes through the inclined surface 5b while being refracted away from the LED 2 in the x direction. To properly receive the refracted light, the center of the photodiode 3 is offset from the central axis C_{5b} of the inclined surface 5b toward the opposite side of the LED 2.

According to this embodiment, the distance between the photodiode 3 and the LED 2 can be increased. Therefore, for example, a block wall for blocking infrared light can be easily provided between the photodiode 3 and the LED 2. Further, even when the distance between the photodiode 3 and the LED 2 is increased, the center-to-center distance between the lens 5a and the inclined surface 5b does not need to be increased more than necessary. Therefore, the lens 5a and the inclined surface 5b can be made to have a proper size. Although the inclined surface 5b is flat in this embodiment, the inclined surface 5b may be convexly curved similarly to the embodiments shown in FIGS. 3-5.

The optical communication module according to the present invention is not limited to the foregoing embodiments, and the specific structure of each part can be modified in various ways.

The optical communication module according to this embodiment may be so designed as to utilize light rays of wavelengths other than those of infrared light. Therefore, the kinds of the light emitting element and the light receiving element and the material of the sealing resin and so on are not limited to specific ones.

The optical communication module according to the present invention is not limited to one to be incorporated in a cell phone for use. For example, the optical communication module may be incorporated in various apparatuses such as a personal computer, a PDA (Personal Digital Assistance) or a facsimile machine, and the application thereof is not limited.

1. An optical communication module comprising:
a substrate;
a light emitting element and a light receiving element mounted on the substrate; and
a sealing resin member that is transparent to light emitted from the light emitting element and covers both the light emitting element and the light receiving element;
the sealing resin member being formed with a lens facing the light emitting element;
the sealing resin member being further formed with an inclined surface that is adjacent to the lens and inclined with respect to both a first direction in which the light emitting element and the light receiving element are arranged side by side and a second direction extending from the light emitting element to the lens;
the light receiving element being arranged to receive light refracted in passing through the inclined surface.

2. The optical communication module according to claim 1, wherein the inclined surface is inclined in the first direction so that the inclined surface becomes closer to the substrate as proceeding away from the lens.

3. The optical communication module according to claim 2, wherein the inclined surface is entirely or partially curved convexly as viewed in the first direction.

4. The optical communication module according to claim 1, wherein the inclined surface is inclined in the first direction so that the inclined surface becomes farther from the substrate as proceeding away from the lens.

5. The optical communication module according to claim 1, wherein the lens projects in a direction to become farther from the substrate than the inclined surface is.

6. The optical communication module according to claim 1, wherein the light emitting element emits infrared light, whereas the light receiving element receives and detects the infrared light.
